(19) United States
(12) Patent Application Publication
(10) Pub. No.: US 2019/0046929 A1
(43) Pub. Date: Feb. 14, 2019

(54) SEPARATION MEMBRANE ELEMENT

(71) Applicant: TORAY INDUSTRIES, INC., Tokyo (JP)

(72) Inventors: Hiroho HIROZAWA, Shiga (JP); Keita WADA, Shiga (JP); Satoko MORIOKA, Shiga (JP); Kentaro TAKAGI, Shiga (JP); Hiroyuki YAMADA, Shiga (JP); Kiyoshi MINOURA, Shiga (JP); Hiroshi NAGAI, Shiga (JP)

(73) Assignee: TORAY INDUSTRIES, INC., Tokyo (JP)

(21) Appl. No.: 16/073,604

(22) PCT Filed: Jan. 27, 2017
(86) PCT No.: PCT/JP2017/002906

§ 371 Date: Jul. 27, 2018

(30) Foreign Application Priority Data
Jan. 29, 2016 (JP) 2016-015153
Apr. 27, 2016 (JP) 2016-088893
Sep. 8, 2016 (JP) 2016-175320

(51) Int. Cl. B01D 63/10; C02F 1/44; B01D 61/02; B01D 65/08

(52) U.S. Cl. CPC B01D 63/10; C02F 1/441; B01D 2311/04; B01D 65/08; B01D 61/025

(57) ABSTRACT

The present invention provides a separation membrane element packed with a rugged sheet object, the separation membrane element being effective in attaining both stabilization of steps for producing the separation membrane element and an increase in fresh-water production rate. The present invention relates to a separation membrane element including: a separation membrane; and a permeate-side channel material disposed on a permeate side of the separation membrane, in which the permeate-side channel material is a porous sheet object having a recess and a protrusion on at least one face thereof, the recess being a coarsely porous region and the protrusion being a densely porous region.

### TECHNICAL FIELD

The present invention relates to a separation membrane element for use in separation of ingredients contained in fluids such as liquid and gas.

### BACKGROUND ART

In the recent technique for removal of ionic substances contained in seawater, brackish water, or the like, separation methods utilizing separation membrane elements have found increasing uses as processes for energy saving and conservation of resources.

Separation membranes adopted in the separation methods utilizing separation membrane elements are classified into five groups according to their pore sizes and separation performance, namely microfiltration membranes, ultrafiltration membranes, nanofiltration membranes, reverse osmosis membranes, and forward osmosis membranes. These membranes have been used, for example, in production of drinkable water from seawater, brackish water, water containing deleterious substances, or the like, production of ultrapure water for industrial uses, effluent treatment, recovery of valuable substances, or the like, and have been used properly according to ingredients targeted for separation and separation performance requirements.

Separation membrane elements have various shapes, but they are common in that they feed raw water to one surface of a separation membrane and obtain a permeated fluid from the other surface thereof. By having a plurality of separation membranes tied in a bundle, each separation membrane element is configured to extend the membrane area per separation membrane element, in other words, to increase the amount of a permeated fluid obtained per separation membrane element.

Various types of shapes, such as a spiral type, a hollow fiber type, a plate-and-frame type, a rotating flat-membrane type, and a flat-membrane integration type, have been proposed for separation membrane elements, according to their uses and purposes.

For example, spiral-type separation membrane elements have been widely used in reverse osmosis filtration. The spiral-type separation membrane element includes a central tube and a stack wound up around the central tube. The stack is formed by staking a feed-side channel material for feeding raw water (that is, water to be treated) to a surface of a separation membrane, a separation membrane for separating ingredients contained in the raw water, and a permeate-side channel material for leading into the central tube a permeate-side fluid having been separated from the feed-side fluid by passing through the separation membrane. In the spiral-type separation membrane element, it is possible to apply pressure to the raw water, and therefore, it has been preferably used in that a large amount of a permeated fluid can be taken out.

In the spiral-type separation membrane element, generally, a net made of a polymer is mainly used as the feed-side channel material in order to form a flow channel for the feed-side fluid. In addition, a multilayer-type separation membrane is used as the separation membrane. The multilayer-type separation membrane is a separation membrane includes a separation functional layer formed of a cross-linked polymer such as polyamide, a porous resin layer (porous supporting layer) formed of a polymer such as polysulfone, and a nonwoven fabric substrate made of a polymer such as polyethylene terephthalate, which are stacked from a feed side to a permeate side. Also, as the permeate-side channel material, a knitted fabric member referred to as tricot, which is finer in mesh than the feed-side channel material, has been used for the purposes of preventing the separation membrane from sinking and of forming a permeate-side flow channel.

In recent years, from increased demands for reduction in cost of fresh water production, separation membrane elements having higher performance have been required. For example, in order to improve separation performance of the separation membrane elements and to increase the permeated fluid amount per unit time, improvements in performance of separation membrane element members such as channel materials have been proposed.

Specifically, Patent Document 1 proposes a separation membrane element includes a channel material including a nonwoven fabric and yarns disposed thereon. Patent Document 2 proposes a separation membrane element for which a general-purpose film was imprinted to form dots or the like and which has the improved property of passing liquids in film-surface directions.

### BACKGROUND ART DOCUMENT

### Patent Document

Patent Document 1: US 2012/0261333

Patent Document 2: JP-A-2006-247453

### SUMMARY OF THE INVENTION

Problems that the Invention is to Solve

However, Patent Document 1 has a drawback in that since a molten thermoplastic resin is infiltrated into and fixed to a sheet having pores in the surface, such as a nonwoven fabric, the production process is complicated and requires a larger-scale production apparatus. Meanwhile, in the case of employing a channel material which is not porous as in Patent Document 2, the channel material has no spaces inside and the flow of the liquid which is passing along the channel material is restricted accordingly, resulting in a problem in that the separation membrane element obtained has a reduced fresh-water production rate.

An object of the present invention is to provide a separation membrane element packed with a rugged sheet object, the separation membrane element being effective in attaining both stabilization of steps for producing the separation membrane element and an increase in fresh-water production rate.

### Means for Solving the Problems

In order to achieve the above-described object, the present invention provides a separation membrane element including: a separation membrane; and a permeate-side channel material disposed on a permeate side of the separation membrane, in which the permeate-side channel material is a porous sheet object having a recess and a protrusion on at least one face thereof, the recess being a coarsely porous region and the protrusion being a densely porous region.

In addition, according to a preferred embodiment of the present invention, the separation membrane element in which the recess has a surface pore ratio of 50% or less, is provided.

In addition, according to a preferred embodiment of the present invention, the separation membrane element in which, in a cross-section of the protrusion which is perpendicular to a longitudinal direction of the protrusion and which passes through a longitudinal-direction center of the protrusion, the protrusion has a ratio of an area of the cross-section to the product of a width and a height of the protrusion of 0.55-0.99, is provided.

In addition, according to a preferred embodiment of the present invention, the separation membrane element in which the recess and the protrusion of the permeate-side channel material are disposed on one face of the permeate-side channel material, is provided.

### Advantage of the Invention

The present invention can attain a reduction in permeate-side channel resistance by enhancing the evenness in the cross-sectional shape of the channel and rendering the disposition of openings in the sheet suitable and can further attain crease inhibition during roll-to-roll conveyance in steps for separation membrane element production.

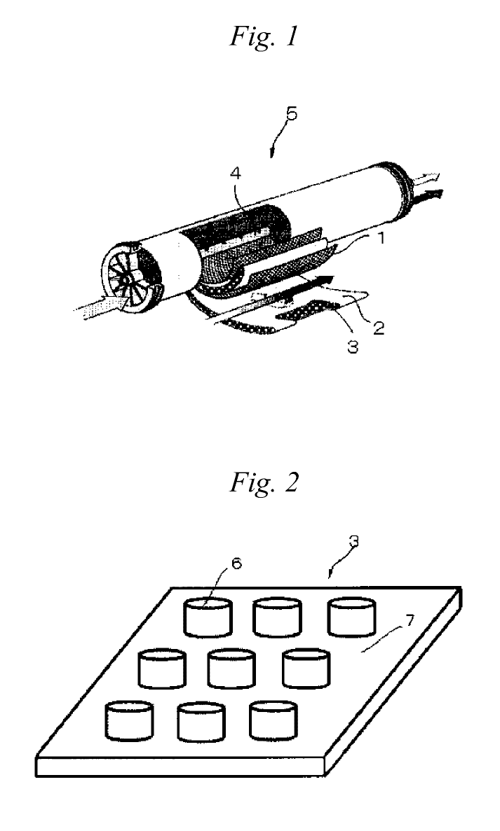

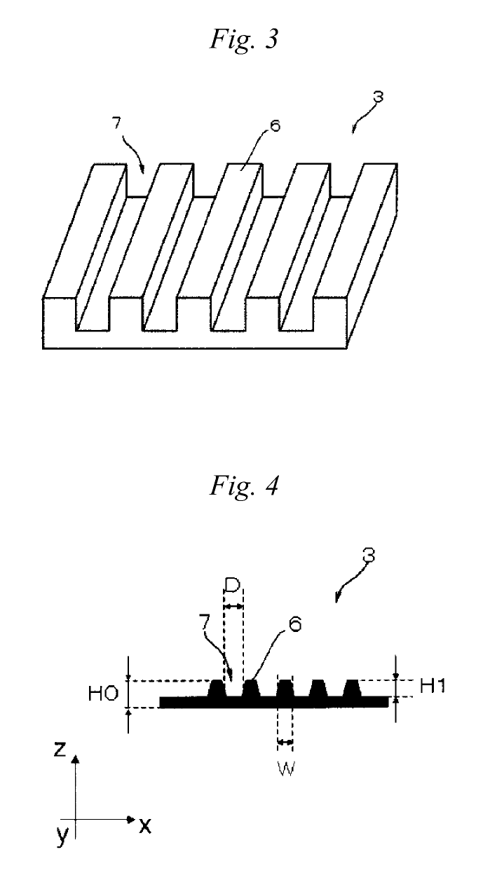

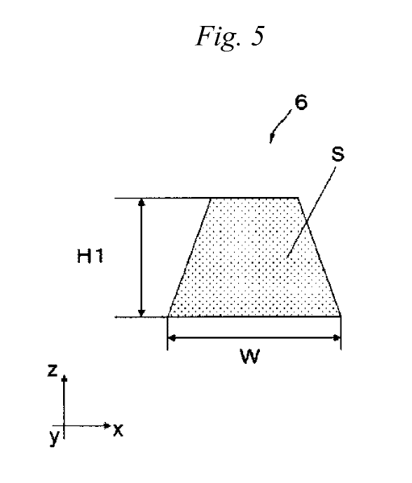

### BRIEF DESCRIPTION OF THE DRAWINGS

[FIG. 1] FIG. 1 is a schematic view showing one example of the separation membrane element of the present invention.

[FIG. 2] FIG. 2 is a slant view showing one example of permeate-side channel materials applicable to the present invention.

[FIG. 3] FIG. 3 is a slant view showing one example of permeate-side channel materials which provides channels arranged side by side along one direction.

[FIG. 4] FIG. 4 is a cross-sectional view of an example of rugged sheets.

[FIG. 5] FIG. 5 is a cross-sectional view of an example of a protrusion of a rugged sheet.

### MODE FOR CARRYING OUT THE INVENTION

Embodiments of the separation membrane element of the present invention are explained in detail below.

### <Outline of the Separation Membrane Element>

Processes for producing the separation membrane element are not limited. As shown in FIG. 1, a feed-side channel material 1 is interposed between separation membranes 2, and a permeate-side channel material 3 is superposed thereon to form a unit, which is spirally wound around a water collection tube 4. Thus, a separation membrane element 5 can be obtained.

In the present invention, the permeate-side channel material 3, which supports the permeate-side face of the separation membrane, which receives the pressure of raw water, is a porous sheet object having a recess and a protrusion on at least one face thereof (hereinafter referred to as “rugged sheet object”), in which the protrusion 6 is densely porous region and the recess 7 is a coarsely porous region. This rugged sheet object is a shaped sheet object.

The term “shaped” means that the sheet object has been processed so that in cases when the shaped sheet object (rugged sheet object) is sandwiched between separation membranes, channel spaces are formed between the rugged sheet object and each separation membrane. Examples of the shaping include: a method in which a sheet object is deformed and the deformed state is fixed; a method in which a surface of a sheet object is bonded to an object made of the same or a different material; and a method in which a sheet object is etched. That is, a rugged sheet object can be obtained by shaping a sheet object.

The recess and protrusion may have been disposed on one face of the permeate-side channel material or may have been disposed on each of both faces thereof.

<Densely Porous Region and Coarsely Porous Region>

The densely porous region in the rugged sheet object is a region in a surface of the rugged sheet object in which the minimum distance between the periphery of any opening and the periphery of a nearest opening is 0.005 mm to 0.1 mm. That is, the number of openings present per unit area of the rugged sheet object is relatively large in the densely porous regions.

Meanwhile, the coarsely porous region is a region in which the minimum distance between the periphery of any opening and the periphery of a nearest opening exceeds 0.1 mm. That is, the coarsely porous region is a region where the number of openings present per unit area of the rugged sheet object is relatively small or where there are no openings.

In the rugged sheet object according to the present invention, the recess is a coarsely porous region. Since the recess is a coarsely porous region, the rugged sheet object has evenness in rigidity and has moderate strength. The rugged sheet object hence is less apt to crease when conveyed and has satisfactory handleability by hand, resulting in a reduced production loss of the rugged sheet object.

Meanwhile, since the protrusion of the rugged sheet object is densely porous region, the holes can serve as channels and the rugged sheet object provides expanded channels along the plane direction of the rugged sheet object. As a result, there is an effect in which the resultant reduction in flow resistance improves the fresh-water production rate of the element.

### (Surface Pore Ratio)

The recess has a surface pore ratio of preferably 50% or less, more preferably 40% or less, even more preferably 5-30%, from the standpoint of enabling the rugged sheet object to have even rigidity and moderate strength as stated above.

### (Method for Determining Surface Pore Ratio)

Methods for determining the surface pore ratio of the rugged sheet object are not particularly limited. Examples thereof include a microscope method. In the microscope method, high-precision configuration analysis system KS-1100, manufactured by Keyence Corp., is, for example, used to photograph a surface of the rugged sheet object at a magnification of 100 times, and the texture value is set at zero to make the image black-and-white. Subsequently, the digital image obtained is analyzed with an image analysis software (ImageJ) to calculate the surface pore ratio using the equation: surface pore ratio (%)=100×[(area of openings)/(cut-out area)]. This procedure is repeated 30 times, and an average value thereof can be taken as the surface pore ratio. By conducting this examination of the rugged sheet object with respect to the protrusion only or the recess only, the surface pore ratio of the protrusion and that of the recess can be determined.

<Thickness of the Rugged Sheet Object>

The thickness H0 of the rugged sheet object shown in FIG. 4 is preferably 0.1 mm to 1 mm. Although film thickness measuring devices of various types, including the electromagnetic type, ultrasonic type, magnetic type, and light transmission type, are commercially available, any non-contact type film thickness measuring device may be used for measuring the thickness of the sheet. A measurement is made on randomly selected ten portions, and an average value thereof is used for evaluation. In cases when the thickness of the rugged sheet object is 0.1 mm or larger, this rugged sheet object has the strength required for permeate-side channel materials and can be handled without suffering collapse of the recess and protrusion or breakage even under stress. Meanwhile, in cases when the thickness thereof is 1 mm or less, the number of separation membranes and channel materials that can be inserted into an element can be increased without impairing the windability around a water collection tube.

<Height of Protrusion and Groove Width of Recess in the Rugged Sheet Object>

The height H1 of the protrusion of the rugged sheet object shown in FIG. 4 is preferably 0.05 mm to 0.8 mm. The groove width D of the recess thereof is preferably 0.02 mm to 0.8 mm. The height H1 of the protrusion and the groove width D of the recess can be measured by examining a cross-section of the rugged sheet object with a commercial microscope or the like.

The height of the protrusion, the groove width of the recess, and the space formed between the rugged sheet object and the separation membrane superposed thereon can provide channels. In cases when the height of the protrusion and the groove width of the recess are within those ranges, a reduction in flow resistance can be attained while inhibiting membrane sinking from occurring during pressure filtration. Thus, a separation membrane element which is excellent in terms of pressure resistance and fresh-water production performance can be obtained.

<Width of Protrusion of the Rugged Sheet Object>

The width W of the protrusion of the rugged sheet object shown in FIG. 4 is not particularly limited and can be determined in accordance with the pressure at which the element is to be operated.

<Material of the Rugged Sheet Object>

With respect to the morphology of the rugged sheet object, use can be made of a knitted fabric, woven fabric, porous film, nonwoven fabric, net, or the like. Especially in the case of nonwoven fabric, spaces serving as channels are formed in a larger amount among the fibers constituting the nonwoven fabric to facilitate the flow of water, resulting in an improvement in the fresh-water production performance of the separation membrane element. Use of a nonwoven fabric is hence preferred.

The material of the polymer constituting the rugged sheet object is not particularly limited so long as the permeate-side channel material retains its shape and dissolution of any component thereof in a permeate is little. Examples thereof include synthetic resins such as polyamide resins, e.g., nylons, polyester resins, polyacrylonitrile resins, polyoletin resins, e.g., polyethylene and polypropylene, poly(vinyl chloride) resins, poly(vinylidene chloride) resins, and polyfluoroethylene resins. Especially from the standpoints of strength which makes the rugged sheet object withstand higher pressures and of hydrophilicity, it is preferred to use a polyolefin resin or a polyester resin.

In the case of a sheet object configured of a plurality of fibers, the fibers may, for example, be ones having a polypropylene/polyethylene core-sheath structure.

<Basis Weight of the Rugged Sheet Object>

The basis weight, i.e., the weight per unit area, of the rugged sheet object is preferably 15-150 g/m². In cases when the basis weight thereof is regulated to preferably 15 g/m² or larger, more preferably 20 g/m² or larger, even more preferably 25 g/m² or larger, the sheet has improved unsusceptibility to positional shifting during shaping and can be evenly shaped, because the rigidity of the sheet tends to increase.

In cases when the basis weight of the rugged sheet object is regulated to preferably 150 g/m² or less, more preferably 120 g/m² or less, even more preferably 90 g/m² or less, this rugged sheet object, even when rolled up, retains flexibility and is hence less apt to break.

<Channels Formed by the Rugged Sheet Object>

After separation membranes are disposed on both faces of the rugged sheet object, the space between a protrusion and an adjacent protrusion can be a channel for permeate. Channels may be ones formed by using a rugged sheet object which itself has been shaped into, for example, a corrugated-sheet shape, a rectangular-wave shape, or a triangular-wave shape, or by using a rugged sheet object in which one face is flat and the other surface has been shaped so as to have recesses and protrusions, or by superposing another member on a surface of a rugged sheet object so as to form a rugged shape on the surface.

<Method for Forming the Rugged Sheet Object>

One method for forming a rugged shape in a surface of a sheet object in order to form channels is imprinting. Imprinting is the following technique. A polymer is heated to or above the glass transition temperature thereof and a die having a rugged shape and similarly heated to or above the glass transition temperature of the polymer is pressed against the polymer. The die generally is a metallic die to which a rugged shape has been imparted by machining. The polymer and the die in the pressed state are cooled, and the die is then removed from the polymer. Thus, the shape of recesses and protrusions which is the reverse of that in the die is transferred to the polymer surface, i.e., the surface of a sheet object.

By subjecting a sheet object to imprinting, a rugged sheet object having columnar projections formed in a dot arrangement such as that shown in FIG. 2, in terms of the plan-view shape of protrusions, can be obtained. In the case of a rugged sheet object having dots disposed in a zigzag arrangement, the stress which occurs when pressurized raw water is supplied is dispersed and this dot arrangement is hence advantageous for inhibiting sinking. Although FIG. 2 shows cylindrical projections each having a circular cross-section (parallel with the plane of the sheet), the cross-sectional shape thereof is not particularly limited and may be a polygonal or elliptic shape, etc. Protrusions differing in cross-sectional shape may coexist.

The rugged sheet object may have a rugged shape having continuous grooves arrange side by side along one direction, as shown in FIG. 3, that is, having protrusions each having a linear plan-view shape.

The separation membrane to be used in the present invention can be produced by a known method. The separation membrane thus obtained and the rugged sheet object are disposed so that the rugged sheet object is brought into contact with the back-side face of the separation membrane to support the separation membrane, and are wound up to obtain a separation membrane element.

It is preferable that the sheet object to be used, that is, the rugged sheet object before being shaped, has the same weight as the shaped sheet object. The sheet object to be shaped is not particularly limited in the width or thickness thereof. However, it is preferred to use a sheet object having a width equal to that of the rugged sheet object and having a thickness not less than one-third the thickness of the shaped sheet object (that is, the largest dimension along the thickness direction of the rugged sheet).

The separation membrane to be packed into the separation membrane element may be any separation membrane having separation properties, such as, for example, a reverse osmosis membrane, ultrafiltration membrane, microfiltration membrane, or gas separation membrane.

The shape of the separation membrane element is not particularly limited. However, the rugged sheet object according to the present invention can exhibit the functions thereof especially when used in the spiral type element, which is required to have highly excellent pressure resistance and liquid or gas permeability.

<Cross-Sectional Shape of Protrusion of the Rugged Sheet Object>

FIG. 5 is a cross-sectional view of a protrusion (the cross-section is perpendicular to the plane of the sheet). This cross-section is perpendicular to the longitudinal direction of the protrusion and passes through the longitudinal-direction center of the protrusion. In this cross-section, the ratio (cross-sectional area ratio A) of the cross-sectional area S of the protrusion to the product of the width W and the height H1 of the protrusion is preferably 0.55-0.99, more preferably 0.6-0.99, even more preferably 0.7-0.99.

That is, the cross-sectional area ratio A is represented by

A=S/(W×H1)

and the ratio A preferably satisfies

### 0.55≤A≤0.99,

more preferably satisfies

### 0.6≤A≤0.99,

and especially preferably satisfies

### 0.7≤A≤0.99.

The width W is a maximum value of width in the cross-section, and the height H1 is a maximum value of height in the cross-section. Consequently, the example shown in FIG. 4 has a trapezoidal cross-sectional shape; and the width W, i.e., the maximum value of width in the cross-section, corresponds to the length of the base of the trapezoid, and the height H1, i.e., the maximum value of height in the cross-section, corresponds to the height of the trapezoid. Like the example shown in FIG. 4, the protrusions each have a cross-sectional shape in which the width increases along the thickness direction, that is, the cross-section has a largest width at the base.

That the cross-sectional area ratio A is 0.99 or less means that in the cross-sectional shape of the protrusion, the width and/or the height is not constant. That is, in a cross-section of a channel material which satisfies that expression, the periphery thereof includes a portion which declines inward from the periphery of a rectangle in which the length of a side is W and the length of each side perpendicular to that side is H1.

In a channel material having a rectangular cross-sectional shape in which the lengths of the sides are W and H1, the value of A is “1”. In this case, the corners of the protrusion have approximately right angles and, hence, may break the separation membrane during operation under pressure to deprive the membrane of the separation properties.

In contrast, the disposition of protrusions which meet the requirement not only enables the rugged sheet object to stably support the separation membrane during operation under pressure but also renders the stress imposed on each protrusion even throughout the whole protrusion. The protrusions hence tend to show a reduced deformation in the same operation under pressure. For such reasons, in the cross-section of each protrusion, the ratio (cross-sectional area ratio A) of the cross-sectional area S of the protrusion to the product of the width W and the height H1 of the protrusion is preferably 0.55-0.99, more preferably 0.6-0.99, even more preferably 0.7-0.99.

### EXAMPLES

The present invention is described below in more detail with reference to Examples. However, the present invention should not be construed as being limited by these Examples.

### (Thickness of Rugged Sheet Object and Height of Protrusions)

The thickness H0 of a rugged sheet object was determined in the following manner. ABS Digimatic Indicator (manufactured by Mitutoyo Corp.; product No. 547-301) was used to examine arbitrarily selected 30 portions of the rugged sheet object. The height values were summed up, and the sum was divided by the number of all the measurement portions (30 portions). The value thus obtained was taken as the thickness H0 of the rugged sheet object.

The height H1 of protrusions was determined in the following manner. High-precision configuration analysis system KS-1100, manufactured by Keyence Corp., was used to examine an area of 5 cm×5 cm, and the results of the examination were analyzed for average height difference. Thirty portions each having a height difference of 10 μm or larger were examined. The height values were summed up, and the sum was divided by the number of all the measurement portions (30 portions). The value thus obtained was taken as the height H1 of the protrusions.

(Width of Protrusions and Groove Width of Recesses in Rugged Sheet Object)

High-precision configuration analysis system KS-1100, manufactured by Keyence Corp., was used to examine 200 portions, and average values were calculated (see FIG. 4). That is, in the case of a protrusion having a trapezoidal cross-section, the width W of the protrusion is the distance between the midpoint between the highest and the lowest points on one side and the midpoint between the highest and the lowest points on the other side. The groove width D of recesses is the distance between the midpoint between the highest and the lowest points of one of two adjacent protrusions and the midpoint between the highest and the lowest points of the other protrusion.

### (Cross-Sectional Area Ratio of Protrusions)

High-precision configuration analysis system KS-1100, manufactured by Keyence Corp., was used to examine arbitrarily selected protrusions of a rugged sheet object to measure the cross-sectional area of each protrusion, such as that shown in FIG. 5. Subsequently, the proportion of the cross-sectional area to the product of the width and the height of the protrusion, which were measured by the method described above, was calculated. An average of such proportion values for arbitrarily selected 30 portions was taken as the cross-sectional area ratio.

### (Surface Pore Ratios of Protrusions and Recesses)

High-precision configuration analysis system KS-1100, manufactured by Keyence Corp., was used to photograph a surface of a rugged sheet object at a magnification of 100 times, and the texture value was set at zero to make the image black-and-white. Subsequently, the digital image obtained was analyzed with an image analysis software (ImageJ) to calculate the surface pore ratio of protrusions using the equation: surface pore ratio of protrusions (%)=100×[(area of openings in protrusions)/(total area of protrusions in the image)]. This procedure was repeated 30 times, and an average value thereof was taken as the surface pore ratio of the protrusions. With respect to recesses, an examination and a calculation were conducted in the same manner.

### (Fresh-Water Production Rate)

A separation membrane element was operated for 15 minutes using an aqueous NaCl solution having a concentration of 200 ppm and a pH of 6.5 as feed water under the conditions of an operation pressure of 0.25 MPa and a temperature of 25° C. (recovery, 15%). Thereafter, sampling was performed for 1 minute. The amount (gallons) of the water obtained as a permeate per unit area of the membrane per day was expressed as the fresh-water production rate (gallons/day (GPD)).

### (Removal Ratio (TDS Removal Ratio))

The raw water used and the permeate sampled in the 1-minute operation for determining the fresh-water production rate were examined for TDS concentration by conductivity measurement. The TDS removal ratio was calculated using the following equation.

TDS removal ratio (%)=100×{1−(TDS concentration in permeate)/(TDS concentration in raw water)}

### (Production of Rugged Sheet Objects)

A polypropylene/polyethylene core-sheath nonwoven fabric (Stratech, manufactured by Idemitsu Unitech Co., Ltd.) was subjected to imprinting to obtain rugged sheet objects. Specifically, the polypropylene/polyethylene core-sheath nonwoven fabric was interposed between metallic dies in which grooves had been formed by machining. This stack was kept being pressed at 15 MPa at 100-140° C. for 2-5 minutes and cooled at 40° C. Thereafter, the nonwoven fabric was removed from the dies. Thus, the rugged sheet objects shown in Tables 1 and 2 were obtained. “MD” in the tables is the direction perpendicular to the longitudinal direction of the water collection tube in the spiral type element.

TABLE 1

| | | Example 1 | Example 2 | Example 3 | Example 4 | Example 5 | Example 6 |
|---|---|---|---|---|---|---|---|
| Rugged | Thickness H0 | 0.26 | 0.26 | 0.26 | 0.26 | 0.26 | 0.26 |
| sheet | (mm) | | | | | | |
| object | Disposition of | one | one | one | one | one | one |
| | recesses and | face | face | face | face | face | face |
| | protrusions | | | | | | |
| Protrusions | Regions | densely | densely | densely | densely | densely | densely |
| | | porous | porous | porous | porous | porous | porous |
| | Surface pore ratio | 77 | 75 | 77 | 72 | 73 | 72 |
| | (%) | | | | | | |
| | Plan-view shape | linear | linear | linear | linear | linear | linear |
| | | (MD) | (MD) | (MD) | (MD) | (MD) | (MD) |
| | Height H1 (mm) | 0.21 | 0.21 | 0.21 | 0.21 | 0.21 | 0.21 |
| | Width W (mm) | 0.4 | 0.4 | 0.4 | 0.4 | 0.4 | 0.4 |
| | Cross-sectional | 0.55 | 0.56 | 0.55 | 0.71 | 0.93 | 0.93 |
| | area ratio | | | | | | |
| Recesses | Regions | coarsely | coarsely | coarsely | coarsely | coarsely | coarsely |
| | | porous | porous | porous | porous | porous | porous |
| | Surface pore ratio | 50 | 2 | 38 | 23 | 25 | 20 |
| | (%) | | | | | | |
| | Groove width D | 0.8 | 0.8 | 0.8 | 0.8 | 0.8 | 0.8 |
| | (mm) | | | | | | |
| Performance | Fresh-water | 84 | 85 | 86 | 88 | 88 | 88 |
| | production | | | | | | |
| | rate (GPD) | | | | | | |
| | Removal ratio (%) | 85.1 | 85.1 | 85.1 | 85.1 | 84.9 | 84.9 |

TABLE 2

| | | | | Comparative | Comparative |
|---|---|---|---|---|---|
| | | Example 7 | Example 8 | Example 1 | Example 2 |
| Rugged | Thickness H0 | 0.26 | 0.26 | — | 0.26 |
| sheet object | (mm) | | | | |
| | Disposition of | both | one | — | one |
| | recesses and | faces | face | | face |
| | protrusions | | | | |
| Protrusions | Regions | densely | densely | — | coarsely |
| | | porous | porous | | porous |
| | Surface pore ratio | 73 | 80 | — | 0 |
| | (%) | | | | |
| | Plan-view shape | linear | dots | — | linear (MD) |
| | | (MD) | | | |
| | Height H1 (mm) | 0.21 | 0.21 | — | 0.21 |
| | Width W (mm) | 0.4 | 0.4 | — | 0.4 |
| | Cross-sectional | 0.92 | 0.98 | — | 0.5 |
| | area ratio | | | | |
| Recesses | Regions | coarsely | coarsely | — | densely |
| | | porous | porous | | porous |
| | Surface pore ratio | 23 | 22 | — | 88 |
| | (%) | | | | |
| | Groove width D | 0.8 | 0.8 | — | 0.8 |
| | (mm) | | | | |
| Performance | Fresh-water | 90 | 93 | 81 | 75 |
| | production | | | | |
| | rate (GPD) | | | | |
| | Removal ratio (%) | 84.9 | 84.8 | 85.0 | 85.0 |

### Example 1

A 15.2% by mass DMF solution of a polysulfone was cast in a thickness of 180 um on a nonwoven fabric made of poly(ethylene terephthalate) fibers (fiber diameter, 1 dtex; thickness, about 0.09 mm; density, 0.80 g/cm³) at room temperature (25° C.). Immediately thereafter, the fabric was immersed in pure water, allowed to stand therein for 5 minutes, and then immersed in 80° C. hot water for 1 minute, thereby producing a porous supporting layer (thickness, 0.13 mm) constituted of a fiber-reinforced polysulfone supporting membrane.

Thereafter, a roll of the porous supporting layer was unwound, and an aqueous solution containing 1.4% by weight m-PDA and 4.1% by weight ϵ-caprolactam was applied thereto. Nitrogen was blown from an air nozzle against the coated surface of the supporting membrane to remove the excess aqueous solution therefrom. Thereafter, a 25° C. n-decane solution containing 0.05% by weight trimesoyl chloride was applied thereto so that the surface was completely wetted thereby. This coated membrane was allowed to stand still for 1 minute. The membrane was then vertically held for 1 minute in order to remove the excess solution therefrom. Thereafter, the membrane was rinsed with 90° C. hot water for 2 minutes, thereby obtaining a separation membrane roll.

The separation membrane thus obtained was folded and cut so as to result in an effective area in a separation membrane element of 0.5 m². A net (thickness, 0.5 mm; pitch, 3 mm×3 mm; fiber diameter, 250 μm; projected area ratio, 0.25) was used as a feed-side channel material. Using the cut separation membrane and the net, a leaf having a width of 260 mm and a leaf length of 1,200 mm was produced.

The rugged sheet object shown in Table 1 was interposed as a permeate-side channel material between the permeate-side face portions of the leaf obtained, and the resultant stack was spirally wound around a water collection tube (width, 350 mm; diameter, 18 mm; number of holes, 10 holes linearly arranged in a row) made of ABS (acrylonitrile/butadiene/styrene). A film was further wound around the periphery. After the wound members were fixed with a tape, edge cutting and end plate attachment were performed. Thus, a separation membrane element having a diameter of 2 inches was produced.

The separation membrane element was loaded in a pressure vessel and evaluated for the performances under the conditions shown above. The results obtained are shown in Table 1.

### Examples 2 to 8

Separation membranes and separation membrane elements were produced in completely the same manner as in Example 1, except that the rugged sheet object was replaced as shown in Tables 1 and 2.

The separation membrane elements were loaded in pressure vessels and evaluated for the performances under the conditions shown above. The results obtained are shown in Tables 1 and 2.

### Comparative Example 1

A separation membrane element was produced in completely the same manner as in Example 1, except that the permeate-side channel material was replaced with tricot having a continuous shape (thickness, 260 μm; groove width, 400 μm; ridge width, 300 μm; groove depth, 105 μm; made of poly(ethylene terephthalate)).

The separation membrane element was loaded in a pressure vessel and evaluated for the performances under the conditions shown above. The results obtained are shown in Table 2. That is, since the tricot had a dense structure to result in high flow resistance, the element tended to show a low fresh-water production rate.

### Comparative Example 2

A separation membrane element was produced in completely the same manner as in Example 1, except that the rugged sheet object shown in Table 2 obtained by bonding a hot-melt resin (PHC-9275, manufactured by Sekisui Fuller Co., Ltd.) to a nonwoven fabric was used as a permeate-side channel material.

The separation membrane element was loaded in a pressure vessel and evaluated for the performances under the conditions shown above. The results obtained are shown in Table 2. That is, since the recesses were densely porous regions, membrane sinking and deformations were prone to occur during the pressure filtration, resulting in channel clogging and an increase in flow resistance on the permeate side.

As apparent from the results shown in Tables 1 and 2, the separation membrane elements of Examples 1 to 8 according to the present invention had high removal performance even when operated at a high pressure and were capable of yielding a permeate at a sufficiently high rate. The results show that these separation membrane elements stably had excellent separation performance.

While the invention has been described in detail and with reference to specific embodiments thereof, it will be apparent to one skilled in the art that various changes and modifications can be made therein without departing from the spirit and scope thereof This application is based on a Japanese patent application filed on Jan. 29, 2016 (Application No. 2016-015153), a Japanese patent application filed on Apr. 27, 2016 (Application No. 2016-088893), and a Japanese patent application filed on Sep. 8, 2016 (Application No. 2016-175320), the entire contents thereof being incorporated herein by reference.

### DESCRIPTION OF REFERENCE NUMERALS AND SIGNS

1 Feed-side channel material
2 Separation membrane
3 Permeate-side channel material
4 Water collection tube
5 Separation membrane element
6 Protrusion
7 Recess
A Cross-sectional area ratio
D Groove width
H0 Thickness of rugged sheet object
H1 Height of protrusion of rugged sheet object
S Cross-sectional area of protrusion of rugged sheet object
W Width of protrusion of rugged sheet object

1-4. (canceled)

5. A separation membrane element comprising: a separation membrane; and a permeate-side channel material disposed on a permeate side of the separation membrane,
wherein the permeate-side channel material is a porous sheet object having a recess and a protrusion on at least one face thereof, the recess being a coarsely porous region and the protrusion being a densely porous region.

6. The separation membrane element according to claim 5, wherein the recess has a surface pore ratio of 50% or less.

7. The separation membrane element according to claim 5, wherein, in a cross-section of the protrusion which is perpendicular to a longitudinal direction of the protrusion and which passes through a longitudinal-direction center of the protrusion, the protrusion has a ratio of an area of the cross-section to the product of a width and a height of the protrusion of 0.55-0.99.

8. The separation membrane element according to claim 6, wherein, in a cross-section of the protrusion which is perpendicular to a longitudinal direction of the protrusion and which passes through a longitudinal-direction center of the protrusion, the protrusion has a ratio of an area of the cross-section to the product of a width and a height of the protrusion of 0.55-0.99.

9. The separation membrane element according to claim 5, wherein the recess and the protrusion of the permeate-side channel material are disposed on only one face of the permeate-side channel material.

10. The separation membrane element according to claim 6, wherein the recess and the protrusion of the permeate-side channel material are disposed on only one face of the permeate-side channel material.

11. The separation membrane element according to claim 7, wherein the recess and the protrusion of the permeate-side channel material are disposed on only one face of the permeate-side channel material.

12. The separation membrane element according to claim 8, wherein the recess and the protrusion of the permeate-side channel material are disposed on only one face of the permeate-side channel material.
